(19) United States
(12) Patent Application Publication
(10) Pub. No.: US 2015/0336183 A1
(43) Pub. Date: Nov. 26, 2015

(54) BORE ADAPTOR

(71) Applicant: Stephen G. KARL, Aloha, OR (US)

(72) Inventor: Stephen G. KARL, Aloha, OR (US)

(21) Appl. No.: 14/719,708

(22) Filed: May 22, 2015

Related U.S. Application Data
(60) Provisional application No. 62/002,026, filed on May 22, 2014.

(51) Int. Cl. B23B 51/00; B23B 51/04

(52) U.S. Cl. CPC B23B 51/0054; B23B 51/0426; B23B 2251/46; B23B 2270/54

(57) ABSTRACT

An adapter with arbor and engagement plane to stabilize a variety of hole enlargement devices such as hole saws and rotary cutters.

### CROSS-REFERENCE TO RELATED APPLICATIONS

This application claims priority under 37 USC §119 to U.S. Provisional patent application No. 60/002,026, filed May 22, 2014.

### BACKGROUND OF THE INVENTION

Many jobs in construction require a hole of some kind to be drilled—whether it is for running conduit, electrical or cable wiring, or joining and fitting. It is not uncommon to find that a drilled hole is unsatisfactory, and that drilling in an alternate location is not an option. Rather, what is required is to bore the hole to the proper dimension and finish, to straighten an original drilled or cored holes and correct defects, or to make holes concentric with an outside diameter.

In standard operation, a bore may slip out of alignment when it is used to enlarge an existing hole. This can damage the work piece. Concern about such slippage causes delays in work. The cost and additional time to address this problem posed a problem which to date has not had a good solution.

### SUMMARY OF THE INVENTION

Disclosed herein is an adapter to stabilize a variety of hole enlargement devices such as hole saws and rotary cutters.

### DESCRIPTION OF THE SEVERAL DRAWINGS

FIG. 1 is an exploded perspective view of a hole saw, showing a spiral bit removed and an adapter ready for engagement.

FIG. 2 is a perspective view of the adaptor and hole saw of FIG. 1.

FIG. 3 is exploded perspective view of a rotary cutter, showing a bore bit removed and an adapter ready for engagement.

FIG. 4 is a perspective view of the adaptor and rotary cutter of FIG. 3.

### DETAILED DESCRIPTION

In application, the torque and axial force applied as the bore contacts the work piece can cause the bore to slip or move off course, damaging the work piece or injuring the drill operator. Use of the original hole as a pilot hole does not ameliorate this risk.

A flat wood bit often used for boring includes a center point to locate the bit and the flat steel on either side cuts away work piece leaving a flat bottomed hole with a central point. These bit are suboptimal for many boring applications where a flat bottomed hole with central point is undesirable. Additionally, a flat wood bit of this type is not ideal for larger or deeper holes, where the bits cause a lot of splintering and require a supplemental backing board to reduce this splintering. Most importantly, these bits rely on a relatively small center point for locating the bits, and which, in expanding a hole, is not available in the vacuum.

This invention relates to improvements in the art of boring, and, more particularly, to improvements in a boring machine to enlarge a previously created hole.

Examples presented for an improvement to a bore are illustrated by examples of a hole saw and a rotary cutter used in conjunction with a drill. Those skilled in the art will appreciate that the same technology could be used with braces, augers, gimlets, push drills, and pin chucks.

The adapter includes an alignment mechanism to assist in the enlargement of existing holes.

In operation, the standard self-feed bit is removed from the bore of the size of the new holes to be drilled, and the alignment adapter is installed with the round arbor being the size of the existing hole. This arbor keeps the drill centered on the existing hole while the new size is enlarging the existing hole.

The arbor may come in a variety of sizes. In one embodiment, a kit with three arbors is provided. For example, a set may contain arbors for 1″, 1½″, and 2″ holes. The arbors are sized to approximately 1/16″ smaller than commonly seen drilled holes to avoid friction. For example, to redrill a 1½″ hole, the self-feed bit from a drill is removed and the arbor indicated for 1½″ holes is secured in its place, where the arbor will have a diameter of approximately 1.438″.

The arbors are preferentially powder-coated steel, which allows for marking for size and makes the arbors rust-resistant.

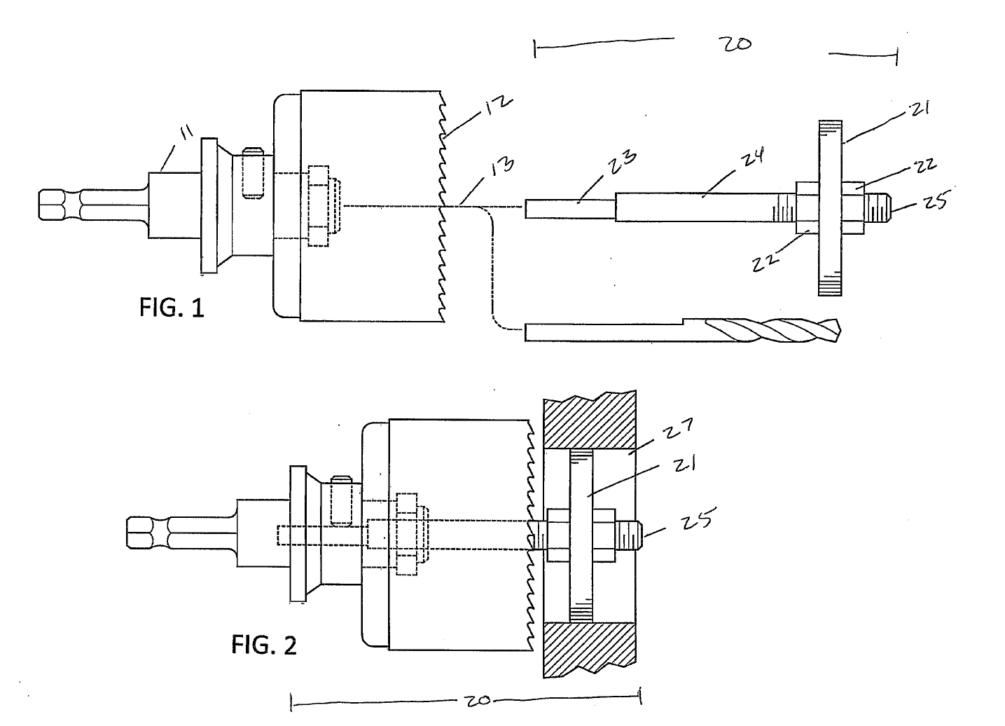

Referring to FIGS. 1 and 2, a motor shaft extends outward from the drill motor and is enclosed in an annular housing. The housing has an elongated opening which underlies shaft (not shown).

The hole saw 11 is attached to the outward end of motor shaft. The hole saw has on its forward or outward end a series of saw teeth 12 extending opposite to each other radially offset of the axis line 13 of the shaft. The saw teeth 12 are so arranged that their cutting edges lie in a common plane perpendicular to the axis of rotation.

The adapter 20 is concentric with the axis of rotation of the saw teeth 12. An interchangeable arbor 21 is provided of a size which corresponds to a pre-existing hole 27. The arbor 21 interlocks with an adapter shaft as shown by a removable means such as nuts 22. The adapter shaft includes an engagement plane 23 for removably interlocking with a mating face on the drill drive shaft.

This hole saw 11 with adapter 20 is very effective in the boring of enlarged holes where maintaining concentric alignment with a pre-existing hole 27 is preferred. The hole saw 11 rotates at an extremely high speed and the adapter 20 and arbor 21 facilitate the boring action and insure that the hole being bored is clean, smooth and the walls of the opening are relatively clean.

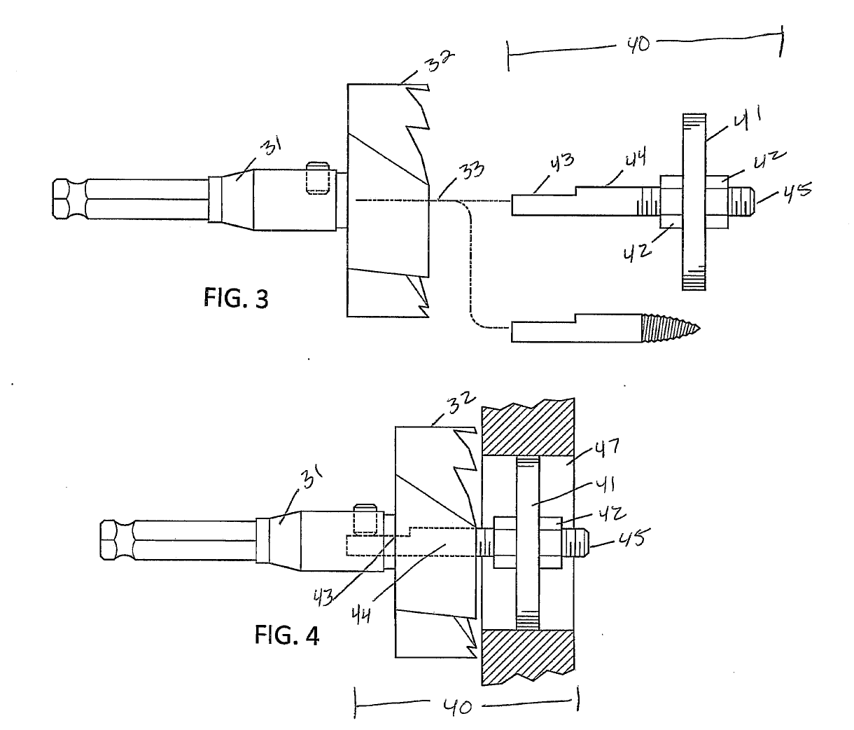

Referring to FIGS. 3 and 4, a motor shaft extends outward from the drill motor and is enclosed in an annular housing. The housing has an elongated opening which underlies shaft (not shown).

The rotary cutter 31 is attached to the outward end of motor shaft. The cutter has on its forward or outward end a pair of opposed cutting edges of blades 32 extending opposite to each other radially or on chords only slightly offset of a diameter line or the axis of the shaft. The cutting edges are preferentially located forward of the diameter line so that the blades 32 overlie said diameter line 33. The blades 32 are so arranged that their cutting edges lie in a common plane perpendicular to the axis of rotation.

The adapter 40 is concentric with the axis of rotation of the cutters of blades 32. An interchangeable arbor 41 is provided of a size which corresponds to a pre-existing hole 47. The arbor interlocks with an adapter shaft as shown by a removable means such as nuts 42. The adapter shaft includes an engagement plane 43 for removably interlocking with a mating face on the drill drive shaft.

This cutting device 31 with adapter 40 is very effective in the boring of enlarged holes where maintaining concentric alignment with a pre-existing hole is preferred. The blades 32 rotate at an extremely high speed and the adapter 40 and arbor 41 facilitate the boring action and insure that the hole being bored is clean, smooth and the walls of the opening are relatively clean.

Use of the adapter 20 requires securing the bore adaptor within a receiving aperture of a drill (not shown), where the adapter 20 consists of (a) a shaft 24 having a first end 25 and second end 26, where the first end has a non-cylindrical cross-section at a lateral engagement plane 23, which plane is capable of engaging with a drive shaft of the drill, and (b) a coaxially aligned an arbor 21 lockingly secured to the shaft at a location near the second end 25, aligning the arbor 21 in an original hole 27, and expanding the original hole by eliminating mass concentrically around the original hole with the hole saw 11.

Use of the adapter 40 requires securing the bore adaptor within a receiving aperture of a drill (not shown), where the adapter 40 consists of (a) a shaft 44 having a first end 45 and second end 46, where the first end has a non-cylindrical cross-section at a lateral engagement plane 43, which plane is capable of engaging with a drive shaft of the drill, and (b) a coaxially aligned an arbor 41 lockingly secured to the shaft at a location near the second end 45, aligning the arbor 41 in an original hole, and expanding the original hole by eliminating mass concentrically around the original hole with the cutting device 31.

The elimination device may be a rotary cutter having an end aperture into which the first end of the shaft is inserted. Alternatively, the elimination device may be hole saw having a cutting surface with a diameter greater than the arbor.

The adapter consists of (a) a shaft having a first and second end, where the first end has a non-cylindrical cross-section at a lateral engagement plane, which plane is capable of engaging with a drive shaft of a drill, (b) an arbor capable of coaxially alignment with the shaft, and (c) a securing device to lockingly secured to the arbor to the shaft at a location near the second end.

The arbor is a disc-shaped formed of steel, provided with a locking mechanism, usually nuts.

For example, the arbors may have diameters of 1.938″, 1.438″, and 0.937″ and may have a width of 0.250″.

For example, the shaft may have an engagement plane with a length of 1″ and cut to a depth of 5/16″- 5/18″ below the lateral surface of the shaft. The shaft may be provided with a shorter overall length for use with rotary cutters, such as 2.5″, and a longer overall length for use with rotary cutters, such as 4″.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A method for stabilization of a bore, the method consisting of securing a bore adaptor within a receiving aperture of a drill, where the adapter consists of (a) a shaft having a first and second end, where the first end has a non-cylindrical cross-section at a lateral engagement plane, which plane is capable of engaging with a drive shaft of the drill, and (b) a coaxially aligned an arbor lockingly secured to the shaft at a location near the second end, aligning the arbor in an original hole, and expanding the original hole by eliminating mass concentrically around the original hole with an elimination device.

2. The method of claim 1 where the elimination device is a rotary cutter having an end aperture into which the first end of the shaft is inserted.

3. The method of claim 1 where the elimination device is a hole saw having a cutting surface with a diameter greater than the arbor.

4. An apparatus consisting of (a) a shaft having a first and second end, where the first end has a non-cylindrical cross-section at a lateral engagement plane, which plane is capable of engaging with a drive shaft of a drill, (b) an arbor capable of coaxially alignment with the shaft, and (c) a securing device to lockingly secured to the arbor to the shaft at a location near the second end.

5. The apparatus of claim 4, where the arbor is a disc-shaped formed of steel, provided with a locking mechanism.
